(19) United States
(12) Patent Application Publication
(10) Pub. No.: US 2013/0321154 A1
(43) Pub. Date: Dec. 5, 2013

(54) EAS Tablet Housing

(71) Applicants: Xiao Hui Yang, Saratoga, CA (US); Xuewei Dai, Shanghai (CN)

(72) Inventors: Xiao Hui Yang, Saratoga, CA (US); Xuewei Dai, Shanghai (CN)

(21) Appl. No.: 13/909,610

(22) Filed: Jun. 4, 2013

Related U.S. Application Data
(60) Provisional application No. 61/655,192, filed on Jun. 4, 2012.

(51) Int. Cl. G08B 13/24

(52) U.S. Cl. CPC G08B 13/2434
USPC 340/572.3

(57) ABSTRACT

An EAS device with a housing. In one embodiment, the EAS housing is a one-piece tray-shaped device with the edges contoured so that the monitored object snaps into the tray or is slid into the tray. Other embodiments may include but are not limited to a two piece housing where one piece of the housing has a protrusion which, when closed together and fitted with the other piece of the housing, engages with a releasable clutch located within the back piece. A clutch within the housing prevents the two pieces of the housing from being disengaged until the clutch is released. The EAS devices carry at least a passive EAS element. More advanced EAS electronic elements may also be carried in the housing.

This application is a non-provisional application claiming priority to U.S. Provisional Application 61/655,192, filed on Jun. 4, 2012. The entire disclosures contained in U.S. Provisional Application 61/655,192, including the attachments thereto, are incorporated herein by reference.

### FIELD OF THE INVENTION

The present application is generally related to electronic article surveillance (EAS) devices that encase and house objects to be monitored. More specifically, the present application relates to EAS devices which encase and house tablet-type devices or other consumer electronics to be monitored, while allowing access to the touch screens, buttons, and accessory jacks of the devices being monitored.

The devices of the present application may also be used with various electronic article surveillance (EAS) systems. The EAS systems may use interrogation zones and passive EAS elements, and may also utilize housings and deactivators using wireless communication for deactivation and alarming, and featuring dynamic time-based passcode modification and other tamper resistant features. The wireless communication may be radio frequency communication or optical communication, such as in the infrared spectrum.

### BACKGROUND OF THE INVENTION

EAS systems have been in use for many years as a means of aiding the deterrence of theft in various types of retail establishments. One common type of EAS device involves the use of a small sensor tag comprised of durable, reliable material. The tag is affixed in such a way to the object to be monitored so as to prevent easy, unauthorized removal of the tag. The EAS device is usually constructed and attached in such a way that it can only be removed from the object being monitored by specialized tools in the possession of authorized store personnel. In the event that an EAS monitoring device is not deactivated or is not removed from an object to be monitored by an authorized person, an alarm or other signal is activated upon removal of the EAS device from the retail establishment. An alarm or other signal is likewise activated upon the unauthorized removal of the EAS device, while the object being monitored is still located within the retail establishment.

In many commercially available EAS systems, one or more antennas are placed at or near the exits and entrances to the retail establishment. These antennas set up what are sometimes referred to as interrogation zones, in which an EAS device may be sensed. At least one antenna serves the function of sending out what is called an interrogation signal. The EAS device, to which the object being monitored is attached, is affected by this signal and will respond with a signal of its own. Either the same antenna that sends out the interrogation signal or other additional antennas can sense the signals from the EAS device. The most effective way to do this is by stopping the broadcast of the interrogation signal to listen for the signals emanating from the EAS device. If an EAS device is sensed within the zone created by the antennas, it is presumed that a monitored object is being removed from the retail establishment without proper authorization, and alarms are set off. These alarms may be audible alarms for general broadcast or the alarms may be silent alarms in the form of a light at a security station, etc. Additionally, some EAS devices have onboard audible alarm generators and can generate audible alarms by themselves. These EAS devices may produce this audible alarm when onboard logic elements determine that the EAS device is being removed from the retail establishment, or when the larger EAS system communicates to the EAS device to alarm. The onboard logic elements and the larger EAS system may also cause the EAS device to cease to alarm under certain situations.

A common manner of attempting to defeat an EAS device is to forcibly disengage it from the item to be monitored. A counter-measure which may be employed by an EAS device is the introduction of a switch which has its state changed and arms, or pre-arms, the EAS device when it is releasably attached to, or joined with, an object to be protected. For example, a switch can be positioned on the EAS device in such a manner that the object bears upon the switch and changes the switch's state when the EAS device and the object are joined together. Alternatively, for EAS devices comprised of multiple pieces, the switch may be located on one piece of the EAS device, and may be borne upon to change the state of the switch when the object to be protected is joined with the EAS device.

Associated devices may communicate with electronics within the EAS device to add an additional step to the device's arming process. When the EAS device is attached to the object to be monitored and the state of the switch is changed, this change of state functions to confirm that the EAS device is installed/attached, and authorized persons can use an associated device to wirelessly communicate with the EAS device to complete the process of arming the EAS device. Once armed, if the EAS device is forcibly disengaged from the object to be monitored, or if the EAS device is removed by an unauthorized person from the object to be monitored, the switch's state changes again, and the electronics of the EAS device determine that an alarm condition exists. The EAS device can sound an audible alarm with an onboard audible alarm generator, or wirelessly communicate an alarm to other elements of the EAS system.

### SUMMARY OF EMBODIMENTS

The EAS device can be constructed so that when the object to be monitored is placed within the EAS device, the EAS device can house and releasably retain the object to be monitored, such as a tablet-shaped object. The tablet-shaped object may have at least one surface which is capable of displaying words, pictures, or a variety of other images. The EAS device can be constructed so that at least one window/opening in the EAS device will permit visual viewing of the surface of the tablet-shaped object which may be displaying various types of images. In some embodiments, the window/opening will permit contact with the surface of the tablet-shaped object.

One embodiment of the EAS device of the present application is a one-piece tray-shaped device into which a tablet-shaped object is snapped or slid into place and releasably retained. The sides of the tray-shaped EAS device are contoured to fit the object to be monitored, and an arcuate lip at the top of the sides of the EAS device slightly overhangs the interior space defined by the EAS device, and serves to clasp and retain the object within the tray. As the object to be monitored is snapped into place and releasably retained by the tray-shaped EAS device, the object bears upon a switch positioned on the tray-shaped EAS device in such a manner that the switch changes its state and arms or pre-arms the tray-shaped EAS device.

Some of the many embodiments of the EAS device may have a housing comprised of multiple pieces. For example, some embodiments of the present device are comprised of two pieces of housing hingedly connected to one another and rotatable between a closed position and one or more open positions. In such embodiments, once the EAS housing is rotated to the closed position, a releasable clutch mechanism maintains the EAS housing in its assembled state to retain the object and deter forcible disassembly of the housing. In some embodiments, the releasable clutch mechanism is a magnetically releasable three ball clutch. The magnetically releasable three ball clutch mechanism is well known to those of ordinary skill in the art, and thus need not be described in detail herein. In some embodiments where the EAS device comprises two pieces of housing, when the EAS device rotates to a closed position, one of the pieces bears upon a switch located on the other piece, which changes the state of the switch and arms the EAS device. In at least one embodiment, the two pieces of housing may be joined by a hinge or hinges.

At least one window/opening in the EAS device permits visual viewing and observation of at least one face of the tablet-shaped object that is releasably retained by the EAS device. The visually-observable face of the tablet may be capable of displaying words, pictures, and other types of visually-observable images, and the EAS device may allow access to the touch screen, buttons, and accessory jacks of the object being monitored.

The types of tablet devices that could be protected by the EAS device may include, but would not be limited to, such things as iPads, iPhones, kindles, and restaurant menus.

The uses for the EAS device may include, but would not be limited to, the encasing and monitoring of interactive restaurant menus from which customers at restaurant establishments may view and select food and drink items.

A person of ordinary skill in the art would understand how to incorporate the improvements described herein into a conventional EAS system.

### BRIEF DESCRIPTION OF THE DRAWINGS

FIG. 1 is a side view of one embodiment of the EAS device having a one-piece, tray-shaped housing.

FIG. 2 depicts a perspective view of the tray-shaped EAS device of FIG. 1 housing a tablet-shaped object, and showing a window/opening through which an image-displaying surface of a tablet-shaped object can be viewed.

FIG. 3 shows a back perspective view of the tray-shaped EAS device.

FIG. 4 is a back perspective view like that of FIG. 3, with EAS electronics within the EAS device exposed.

FIG. 5 is an exploded perspective view of EAS electronics housed within the EAS device.

FIG. 6 is a perspective view of the tray-shaped EAS device like that of FIG. 2, without a tablet-shaped object housed within the device.

### DETAILED DESCRIPTION OF EMBODIMENTS

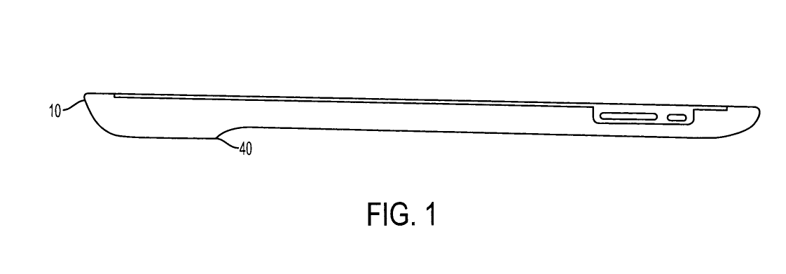

FIG. 1 is a side view of one embodiment of EAS device 10 having a one-piece tray-shaped housing. The contour of EAS device 10 creates a raised area 40 at the back of EAS device 10. Raised area 40 is a central panel which includes the electronics of EAS device 10. Raised area 40 creates a recessed well behind a tablet-shaped object when the object is inserted into EAS device 10.

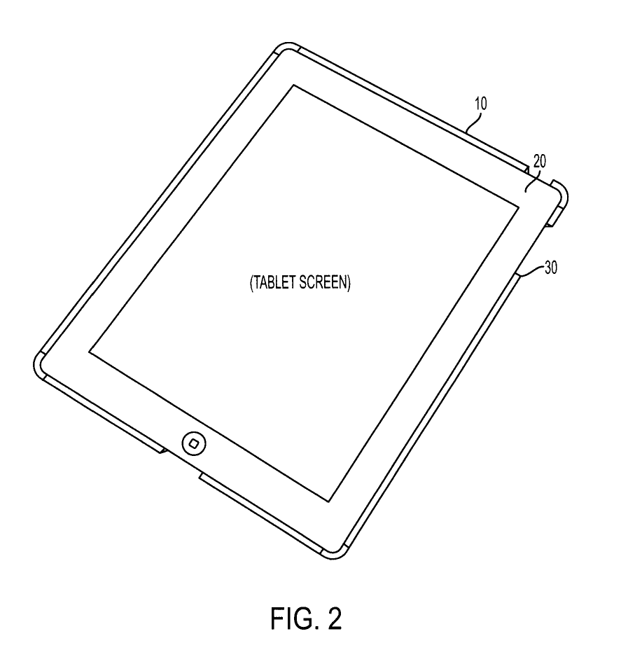

FIG. 2 shows the tray-shaped EAS device 10, within which a computer tablet 30 is encased so as to enable visible observation of an image-displaying surface of a tablet-shaped device 30 through a window/opening 20 of the EAS device 10.

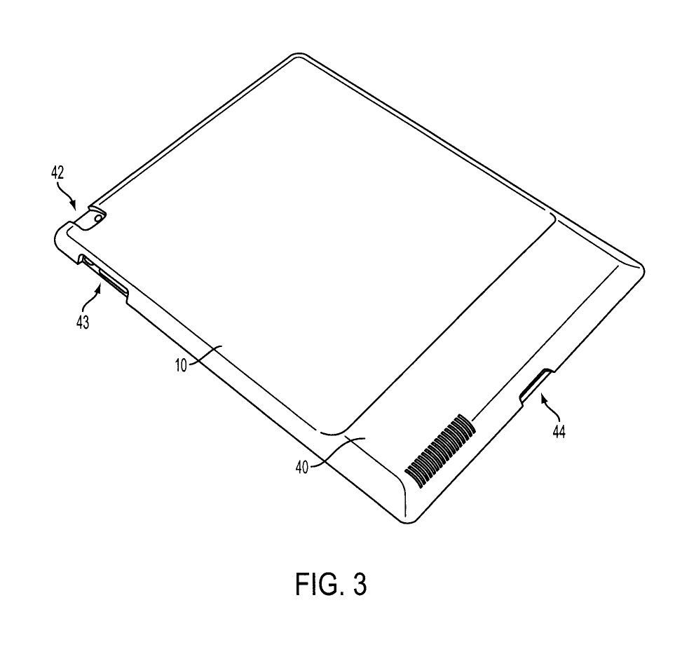

FIG. 3 shows a back perspective view of the tray-shaped EAS device 10. As can be seen in FIG. 3, raised area 40 extends along the width of a portion of EAS device 10. Also visible in FIG. 3 are access notches 42, 43, and 44, which allow access to buttons and/or ports of a tablet-shaped object inserted into EAS device 10.

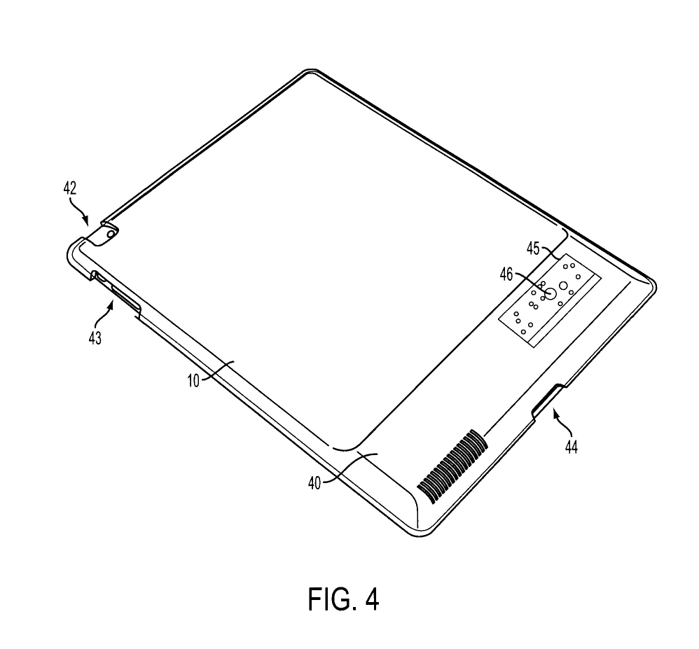

FIG. 4 is a back perspective view like that of FIG. 3. In FIG. 4, a raised area cover (not shown) is removed to reveal space 45. EAS electronics 46 can be seen in space 45.

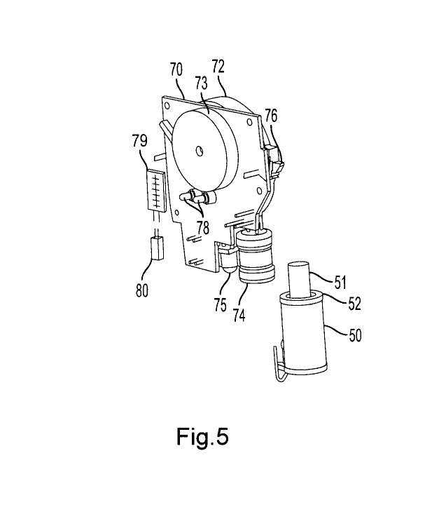

Looking at FIG. 5, space 45 may include circuit board 70 which may provide the structure for electrical connections among the electronic elements. Among the other electronic elements that may be contained within space 45 of EAS device 10 are microprocessor 72, sound generator 73, battery 74, optical communication port 75 which may receive infrared signals, switch 76, light-emitting diode 78 which may transmit infrared signals, radio frequency circuitry 79, and motion detection chip 80.

Microprocessor 72 is capable of storing and executing machine readable instructions to perform logic operations. Microprocessor 72 can communicate with other devices through the wireless communication elements, such as radio frequency communication circuitry 79 or optical communication port 75 and light-emitting diodes 78. These other devices can include the overall EAS system, EAS device deactivators, EAS device programmers, etc. EAS device programmers can reprogram the machine readable instructions stored on the microprocessor 72 as well as provide logic inputs for microprocessor 72 to interpret.

Sound generator 73 can generate audible alarms when microprocessor 72 determines that an alarm situation is present. This may occur when wireless communication elements detect that EAS device 10 is present in an unauthorized area such as an interrogation zone at the exit of a retail establishment. The wireless communication elements can also receive a signal to cease alarming, which signal is communicated to microprocessor 72, which in turn causes sound generator 73 to cease alarming. Sound generator 73 can also communicate that EAS device 10 has been successfully armed, by beeping, etc.

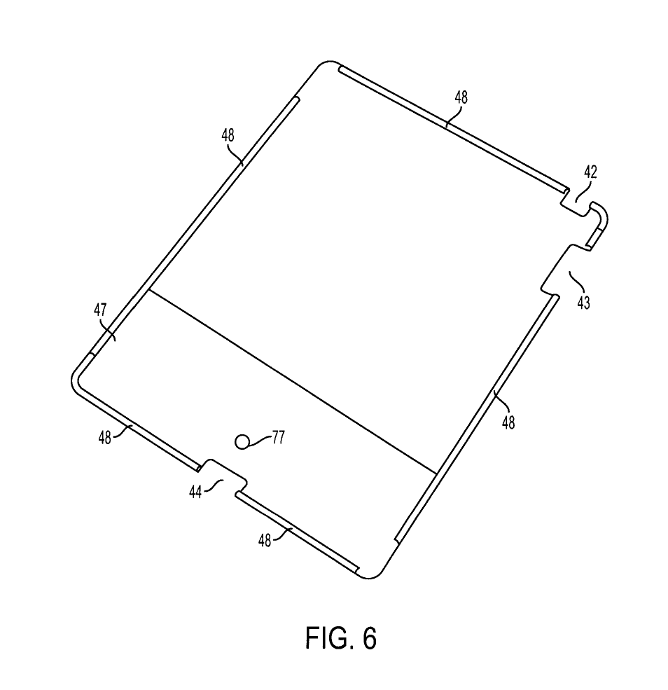

Referring to FIG. 6, an embodiment of the present device is shown without having a tablet-shaped device secured within it. In the embodiment shown, panel 47 creates a barrier between the interior of the present device and space 45 which includes EAS electronics 46. In the embodiment shown in FIG. 6, panel 47 has switch aperture 77. Overhanging edges 48 are also seen in FIG. 6. In the embodiment shown in FIG. 6, overhanging edges are arcuate overhangs located along the top of each of the four sides of EAS device 10. In some embodiments, overhanging edges 48 may be of a contour other than arcuate, and/or may be located along the top of two or more, but less than four, of the sides of EAS device 10.

As a tablet-shaped device is being manually snapped into place to fit within EAS device 10, overhanging edges 48 flex away slightly so that the tablet may be accepted and clasped by EAS device 10. In some of the embodiments, EAS device 10 is comprised of material such as, but not limited to, an elastomer or plastic, that is sufficiently flexible to accept insertion of a tablet-shaped device by snapping it into place within EAS device 10, while also being sufficiently rigid so that EAS device 10 retains the tablet.

In one of the embodiments of the present device, when a tablet-shaped object to be monitored, such as a tablet-shaped device 30, is snapped into place and encased within EAS device 10, switch 76, protruding from switch aperture 77 passing from space 45 to the interior of EAS device 10, is borne upon by tablet-shaped device 30 and depressed. This conveys to microprocessor 72 that the object to be monitored is located within the EAS device 10. If the switch 76 thereafter changes position without a wireless communication from the EAS system to disarm it, microprocessor 72 interprets this as an unauthorized disengagement of the object to be monitored 30 from the EAS device 10, and determines that an alarm condition exists. Microprocessor 72 can then cause sound generator 73 to generate an audible alarm and also generate an alarm signal over the wireless communication elements.

Referring again to FIG. 5, optical communication port 75 aligns with an aperture (not shown) in the housing of EAS device 10. Light-emitting diodes 78 can generate signals for optical communication or may generate more general visual cues for users. In some embodiments, the optical communication may be done in the infrared spectrum range.

In addition to optical communication capabilities, some embodiments of EAS device 10 may have radio frequency capabilities for wireless communication. Radio frequency circuitry 79 may provide this capability. Radio frequency circuitry 79 can transmit and receive signals for communication with other elements of the larger system.

Motion detection chip 80 can detect when EAS device 10 is being moved and can provide an additional logic input for microprocessor 72. For example, the electronics package of EAS device 10 may function at a low level of operation until motion detection chip 80 detects that EAS device 10 is being moved. Microprocessor 72 may then change to a more active mode of operation to monitor the current situation.

In some embodiments of EAS device 10, the electronics package more generally, or microprocessor 72 more particularly, may have a clock function. This clock function can be used to change a passcode for EAS device 10 according to a time-based algorithm. This change in passcode is synchronized with the broader EAS security system. This is an added layer of security against unauthorized disarming of the electronics of the EAS device.

Other EAS electronics housed within raised area 40 may include passive sensor 50. In the embodiment shown in FIG. 5, passive sensor 50 is of the type comprising ferrite core 51, surrounded by electric coil 52. Other types of passive sensors may also be used.

It is to be understood that the embodiments and claims herein are not limited in application to the details of construction and arrangement of the components set forth in the description and illustrated in the drawings. Rather, the description and the drawings provide examples of the embodiments envisioned, but the claims are not limited to any particular embodiment or to a preferred embodiment disclosed and/or identified in the specification. The drawing figures are for illustrative purposes only, and merely provide practical examples of the EAS Tablet Housing device disclosed herein. Therefore, the drawing figures should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is understood that the phraseology and terminology employed herein are for the purpose of description and should not be regarded as limiting the claims.

I claim:

1. An EAS device for a portable electronic device, said EAS device comprising;
a housing adapted to secure a tablet within said housing;
said housing configured so that an image-displaying top surface of a tablet secured within said housing is substantially uncovered, and the sides and non-image-displaying bottom surface of said tablet are substantially covered;
said housing having a plurality of apertures located about the periphery of said housing, aligned and configured for accessing buttons, ports, and jacks of said tablet secured within said housing;
said housing having an internal compartment; and
electronics within said internal compartment.

2. The EAS device of claim 1, further comprising;
a configuration adapted to manually snap and clasp a tablet within said housing; and,
material sufficiently flexible to accept manually snapping a tablet within said housing, and sufficiently rigid to retain said tablet within said housing.

3. The EAS device of claim 1, wherein:
said electronics comprise an alarm switch, a circuit board, communication elements, an audible alarm generator, a battery, a microprocessor, machine-readable instructions in said microprocessor for storing a passcode, and a motion detector chip.

4. The EAS device of claim 3, further comprising:
an aperture in said internal compartment through which said alarm switch protrudes.

5. The EAS device of claim 4, wherein:
said alarm switch arms when borne upon by a tablet secured within said housing.

6. The EAS device of claim 5, wherein:
if said alarm switch disarms without authorizing communication being received by said communication elements in said electronics, said electronics determine an alarm condition and generate an alarm.

7. The EAS device of claim 1, wherein:
said electronics further comprise an accurate clock generator, and
said machine readable instructions further comprise an algorithm for generating multiple passcodes, wherein at specific time intervals said algorithm generates a new passcode and a previously stored passcode is replaced by said new passcode.

8. The EAS device of claim 6, wherein:
said communication elements are capable of communicating with external devices to receive signals changing said housing between armed and disarmed states.

9. The EAS device of claim 6, wherein;
said alarm is an audible alarm.

10. The EAS device of claim 6, wherein;
said alarm is an alarm signal broadcast by said communication elements for receipt by devices external to said anti-theft tag.

11. The EAS device of claim 1, further comprising;
a passive electronic article surveillance element.

12. The EAS device of claim 1, wherein said housing comprises;
a tray comprising a central panel with sidewalls around its perimeter, said sidewalls being topped by a lip directed toward an interior space defined by said tray, and said sidewalls having sufficient height to give said tray sufficient depth to accommodate said portable electronic device, and said tray being shaped generally to fit said portable electronic device;
said tray further comprising a well in said central panel, said well recessed in the opposite direction to said sidewalls and creating space for said electronics behind a portable electronic device installed in said housing, said lip on said sidewalls retaining said portable electronic device in said tray.
